(19) United States
(12) Patent Application Publication
(10) Pub. No.: US 2011/0174707 A1
(43) Pub. Date: Jul. 21, 2011

(54) Ballast Water Utilization System

(75) Inventors: Masahiro Saito, Tokyo (JP); Gaku Taniguchi, Tokyo (JP); Syuji Ueki, Tokyo (JP); Taishi Sato, Tokyo (JP)

(73) Assignee: Mitsui Engineering & Shipbuilding Co., Ltd., Tokyo (JP)

(21) Appl. No.: 12/595,674

(22) PCT Filed: May 8, 2007
(86) PCT No.: PCT/JP2007/059534

§ 371 Date: Oct. 13, 2009

(51) Int. Cl. C02F 1/00; C02F 1/32; C02F 1/44; C02F 1/50; B63B 13/00

(52) U.S. Cl. 210/172.1

(57) ABSTRACT

To provide a utilization system of ballast water that can secure cleaning water for cleaning an apparatus and be used for various uses.

A ballast water utilization system including: a ballast water treatment apparatus 3 which is an apparatus for treating microorganisms or bacteria in seawater or freshwater and requires cleaning at least once a day while treatment is continuously performed; and a ballast tank 4 storing ballast water treated by the ballast water treatment apparatus 3, wherein a service tank 5 storing ballast treated water treated by the ballast water treatment apparatus 3 is provided, and the ballast treated water in the service tank 5 is made available for cleaning of the ballast water treatment apparatus 3.

### TECHNICAL FIELD

The present invention relates to ballast water utilization systems, and more particularly to a utilization system of ballast water that can be used as various types of utility water.

### BACKGROUND ART

A cargo ship transporting crude oil or the like has a ballast tank in order to keep the stability of a hull during navigation.

Usually, when the ship is not loaded with crude oil or the like, the ballast tank is filled with ballast water, and the ballast water is discharged when crude oil or the like is loaded into the ship.

The ballast water is water required for safe navigation of the ship, and seawater at a port where cargo handling is carried out is usually used. The amount thereof is estimated to be 3 to 4 billion tons per year on the worldwide basis.

In the ballast water, aquatic organisms living in a port from which the water was taken are mixed, and the aquatic organisms are also transported to foreign countries with the movement of the ship. Therefore, the destruction of an ecological system caused as a result of an organism species which do not originally live in a sea area replacing an existing organism species is getting serious.

Against this background, at a diplomatic conference of the International Maritime Organization (IMO), the Convention for the Control and Management of Ships' Ballast Water and Sediments has been adopted, and an obligation to manage ballast water by using a ballast water treatment apparatus is scheduled to be applied to a ship constructed in 2009 and after.

Also, a ballast-water discharge standard is specified by the above Convention as shown in the table below:

TABLE 1

| | Ballast water | | |
|---|---|---|---|
| Item | quality standard | | Size |
| Aquatic organism | 10 | pieces/ml | 10 to 50 μm |
| Aquatic organism | 10 | pieces/m³ | 50 μm or more |

| | | |
|---|---|---|
| Indicator | Escherichia coli | 250 cfu/100 ml |
| bacteria | Pathogenic Vibrio | 1 cfu/100 ml |
| | cholerae (01, 0189) | |
| | Enterococcus | 100 cfu/100 ml |

It is against this background that the need to develop a ballast water sterilization/bacterial eradication technology that can solve the above problem has become urgent.

As the ballast water sterilization/bacterial eradication technology, an ozone-based chemical method (Patent Document 1), filtration treatment (Patent Document 2), membrane treatment (Patent Document 3), a buffer tank that brings a pump into operation (Patent Document 4), and the like, are conventionally known.
Patent Document 1: JP-A-2004-160437
Patent Document 2: JP-A-2005-152799
Patent Document 3: JP-A-2003-265935
Patent Document 4: JP-A-2005-161292

### DISCLOSURE OF INVENTION

### Problem to be Solved by the Invention

Patent Document 1 proposes a technology for performing sterilization by injecting ozone into ballast water in conjunction with an injection of steam while reducing ozone usage by turning the ozone into microscopic bubbles and thereby promoting the generation of hydroxyl radicals. However, the reduction of ozone usage has its limit.

The filtration treatment and membrane treatment described in Patent Documents 2 and 3 require cleaning of an apparatus to continue operation for long periods.

However, the problem is that, to maintain the safety of navigation of a ship, the ballast water such as seawater or freshwater introduced into the ballast tank cannot be used for other uses.

Therefore, an object of the present invention is to provide a utilization system of ballast water that can secure cleaning water for cleaning an apparatus and be used for various uses.

Other objects of the present invention will become apparent from the following description.

### Means for Solving Problem

The invention according to claim 1 is a ballast water utilization system including: a ballast water treatment apparatus which is an apparatus for treating microorganisms or bacteria in seawater or freshwater and requires cleaning at least once a day while treatment is continuously performed; and a ballast tank storing ballast water treated by the ballast water treatment apparatus, wherein a service tank storing ballast treated water treated by the ballast water treatment apparatus is provided, and the ballast treated water in the service tank is made available for cleaning of the ballast water treatment apparatus.

The invention according to claim 2 is the ballast water utilization system according to claim 1, wherein the ballast water treatment apparatus is a filtering apparatus separating and removing microorganisms and bacteria or a treatment apparatus using mechanical shear.

The invention according to claim 3 is the ballast water utilization system according to claim 1, wherein the ballast water treatment apparatus includes a filtering apparatus separating and removing microorganisms and bacteria and a sterilizing apparatus placed in the following stage of the filtering apparatus and performing sterilization by using a bactericide or ultraviolet light.

The invention according to claim 4 is the ballast water utilization system according to claim 1, wherein the ballast water treatment apparatus includes a treatment apparatus using mechanical shear and a sterilizing apparatus placed in the following stage of the treatment apparatus and performing sterilization by using a bactericide or ultraviolet light.

The invention according to claim 5 is the ballast water utilization system according to claim 3 or 4, wherein the ballast treated water in the service tank is used as water to dilute a bactericide used in the sterilizing apparatus performing sterilization by using a bactericide.

The invention according to claim 6 is the ballast water utilization system according to any one of claims 1 to 5, wherein the ballast treated water in the service tank is introduced into a reverse osmosis membrane treatment apparatus to produce drinking water or reclaimed water.

### Effect of the Invention

According to the present invention, it is possible to provide a utilization system of ballast water that can secure cleaning water for cleaning an apparatus and be used for various uses.

### BRIEF DESCRIPTION OF DRAWINGS

FIG. 1 is an explanatory diagram of a ballast water utilization system in accordance with the present invention;

FIG. 2 is a diagram showing an example of a ballast water treatment apparatus that can be suitably adopted in the present invention;

FIG. 3 is a sectional view of a principal portion of a ballast water treatment apparatus that can be suitably adopted in the present invention; and

FIG. 4 is an explanatory diagram of a ballast water utilization system in accordance with another embodiment of the present invention.

### EXPLANATIONS OF LETTERS OR NUMERALS

1: hull
2: ballast pump
3: ballast water treatment apparatus
30: filtering apparatus
31: treatment apparatus using mechanical shear (shear treatment apparatus)
32: sterilizing apparatus
310: tubular body
311: a plurality of pores
312: shielding plate
4: ballast tank
5: service tank
6: pipe
7: pipe
8: pipe
9: transfer pump
10: pipe

### BEST MODE FOR CARRYING OUT THE INVENTION

Hereinafter, an embodiment of the present invention will be explained by using the drawings.

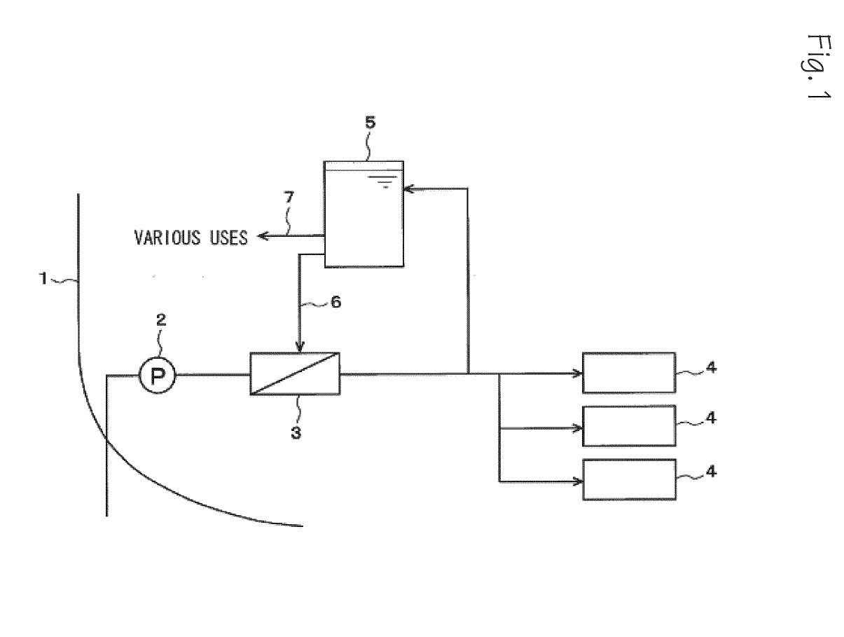

FIG. 1 is an explanatory diagram of a ballast water utilization system in accordance with the present invention. In this drawing, 1 denotes a hull of a ship such as a tanker, and 2 denotes a ballast pump for pumping seawater or freshwater (hereinafter referred to simply as “seawater”) outside the hull 1.

3 denotes a ballast water treatment apparatus which is an apparatus for treating microorganisms or bacteria in seawater or freshwater and requires cleaning at least once a day while treatment is continuously performed.

4 denotes a ballast tank for storing ballast treated water treated by the ballast water treatment apparatus 3.

5 denotes a service tank for storing ballast water treated by the ballast water treatment apparatus 3. It is preferable that the service tank 5 be filled with water by conveying the ballast treated water to the service tank 5 after the ballast tank 4 is filled with the ballast water or in the course of filling the ballast tank therewith.

One service tank 5 may be provided when it is large in capacity, or a plurality of service tanks 5 may be provided when they are small in capacity.

Moreover, the service tank 5 may be formed into any one of a cylindrical shape and a rectangular shape by using normal resin or an anticorrosion steel plate (such as SUS). When a certain space cannot be secured on the ship, a container formed of a flexible material is also preferable. Examples of the service tank formed of a flexible material include, for example, a resin film, a cloth sack or reinforced fiber cloth sack lined with rubber.

6 denotes a pipe for supplying cleaning water to the ballast water treatment apparatus 3. In the present invention, as mentioned above, the ballast water treatment apparatus 3 requires cleaning at least once a day while treatment is continuously performed.

Therefore, the ballast treated water in the service tank 5 is supplied to the ballast water treatment apparatus 3 as the cleaning water.

The ballast water such as seawater or freshwater introduced into the ballast tank cannot be used for uses other than for the safety of navigation of a ship. That is, if such ballast water is used, the ship is at risk of losing a balance and capsizing. For this reason, the need for the service tank 5 in accordance with the present invention arises, and the service tank 5 fulfills an important function. In the past, there was no concept of such a service tank.

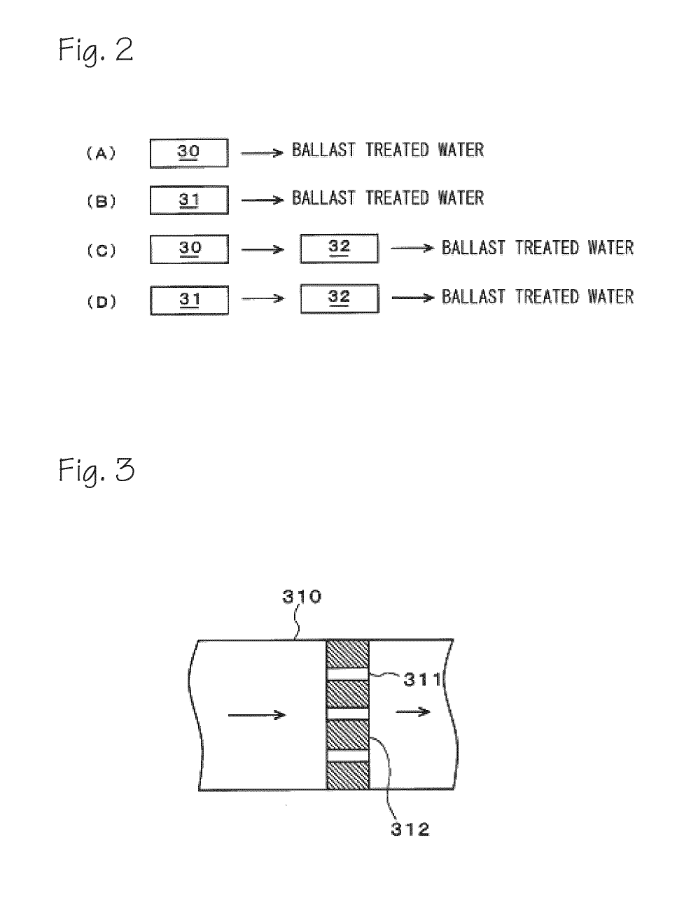

In the present invention, it is preferable that the ballast water treatment apparatus 3 be a filtering apparatus 30 separating and removing microorganisms and bacteria as shown in (A) of FIG. 2 or a treatment apparatus 31 using mechanical shear as shown in (B) of FIG. 2.

Examples of the filtering apparatus 30 separating and removing microorganisms and bacteria include a filtering apparatus using a filtering medium and a membrane filtering apparatus.

With such a membrane treatment apparatus, it is possible to separate and remove microorganisms and bacteria having a size equal to or greater than a pore size of the membrane.

Examples of the membrane filtering apparatus include membrane treatment apparatuses using a filtration membrane (for example, a microfiltration membrane). These membrane treatment apparatuses require membrane cleaning after performing filtration for a predetermined time period because the membrane gets clogged as the treatment continues.

Furthermore, as another preferred embodiment of the present invention, it is preferable that the ballast water treatment apparatus 3 be composed of, as shown in (C) of FIG. 2, the filtering apparatus 30 separating and removing microorganisms and bacteria and a sterilizing apparatus 32 placed in the following stage of the filtering apparatus 30 and performing sterilization by using a bactericide or ultraviolet light.

Examples of the sterilizing apparatus 32 performing sterilization by using a bactericide or ultraviolet light include a sterilizing apparatus using a bactericide such as chlorine or hypochlorous acid or a photooxidation treatment apparatus using an ultraviolet lamp.

It is also preferable that a bactericide and ultraviolet light be used in combination.

The sterilizing apparatus using a bactericide needs dilution water for adjusting the concentration of a bactericide to a predetermined concentration. In the present invention, it is preferable to use the ballast treated water in the service tank as such dilution water. Also in this case, the ballast water in the ballast tank cannot be used for the reason described above.

Incidentally, when an ultraviolet lamp is used, it is also preferable to use the ballast treated water in the service tank for cleaning the ultraviolet lamp.

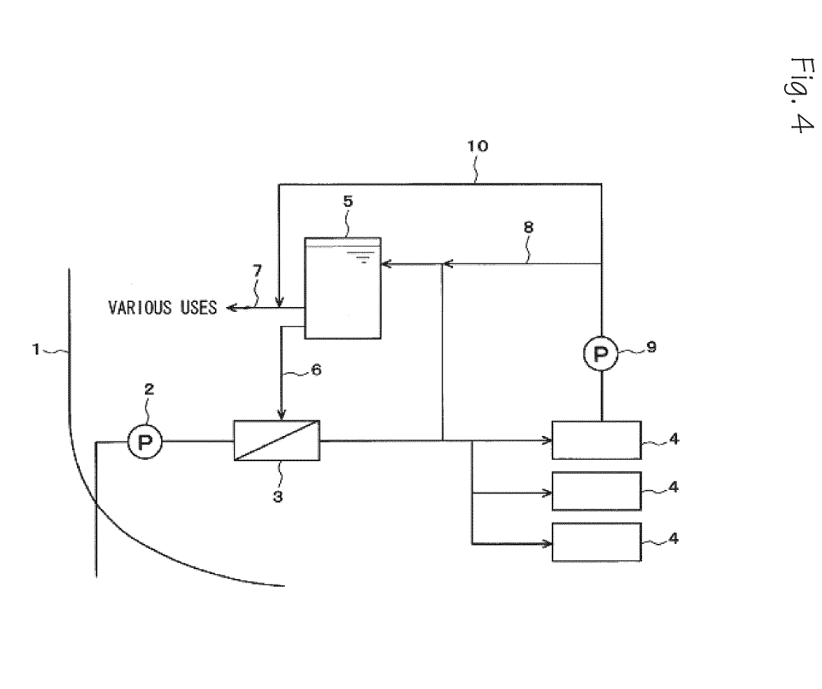

The shear treatment apparatus 31 using mechanical shear is formed as a tubular body 310, as shown in FIG. 3, inside which a shielding plate 312 having a plurality of pores 311 is provided, and performs treatment by introducing seawater or freshwater from one side thereof, making the seawater or freshwater run into the shielding plate 312, and thereby killing a microorganism or the like or putting it in a state of apparent death by tearing the microorganism or the like into pieces by shearing force when the seawater or freshwater is passing through the pore 311.

In the invention, it is preferable that the ballast water treatment apparatus 3 be composed of, as shown in (D) of FIG. 2, the treatment apparatus 31 using mechanical shear and the sterilizing apparatus 32 placed in the following stage of the treatment apparatus 31 and performing sterilization by using a bactericide or ultraviolet light. This is because it is thereby possible to treat microorganisms or bacteria which have passed through the pores 311 of the treatment apparatus 31 and are in a state of apparent death with the sterilizing apparatus without fail.

Incidentally, it is also preferable to place a membrane treatment apparatus using a filtration membrane in the following stage of the treatment apparatus 31 using mechanical shear.

The above-mentioned shear treatment apparatus 31 also requires removal of microorganisms or the like lodged in the pores 311 by cleaning after a lapse of a predetermined time period. Therefore, in the present invention, it is important to use the ballast treated water in the service tank as cleaning water for that purpose as described above. This is a nonconventional idea.

Up to this point, the preferred ballast water treatment apparatuses of the present invention have been explained. In addition to those described above, the preferred embodiments include electrolytic treatment and ion-exchange membrane treatment. These embodiments can be adopted alone or in combination with membrane treatment or shear treatment.

Furthermore, in the present invention, though not illustrated, introducing the ballast treated water in the service tank 5 into a reverse osmosis membrane treatment apparatus and treating the ballast treated water to produce drinking water or reclaimed water is also a preferred embodiment.

Incidentally, in FIG. 1, 7 denotes a pipe for making the ballast treated water in the service tank 5 available for various uses other than the above-described cleaning or the like.

Other various uses include securing of reclaimed water in the ship, securing of deck cleaning water, and the use of the ballast treated water as water to produce hypochlorous acid.

FIG. 4 is an explanatory diagram of a ballast water utilization system in accordance with another embodiment of the present invention. Since such parts as are identified with the same numerals as in FIG. 1 have the same configurations as their counterparts in FIG. 1, their detailed explanations will be omitted.

This embodiment includes a pipe 8 for transferring the ballast water stored in the ballast tank 4 to the service tank 5 with a transfer pump 9.

Therefore, it is possible to transfer the ballast water in the ballast tank 4 which is no longer required at the time of loading of a new cargo, for example, to the service tank 5 via the pipe 8. The ballast water in the ballast tank 4 is clean ballast treated water treated by the ballast water treatment apparatus 3.

As a result, at the time of discharge of ballast water or after discharge thereof, even when ballast treated water is needed for making it available for various uses when the ballast treated water in the service tank 5 is used and is getting low or the service tank is emptied, transferring the ballast water in the ballast tank 4 to the service tank 5 via the pipe 8 eliminates the need to pump new ballast water with the ballast pump 2 and treat it by the ballast water treatment apparatus 3. This makes it possible to make the ballast treated water in the service tank 5 available for use promptly.

Moreover, as also shown in FIG. 4, by additionally providing a pipe 10 for directly supplying the ballast water stored in the ballast tank 4, with the transfer pump 9 and not through the service tank 5, to the pipe 7 for making the ballast water available for various uses, it is possible to make the ballast water in the ballast tank 4 available for use in addition to the ballast treated water in the service tank 5 at the time of discharge of ballast water. This makes it possible to deal with the need to use a large volume of ballast treated water for various uses.

1. A ballast water utilization system comprising:
a ballast water treatment apparatus which is an apparatus for treating microorganisms or bacteria in seawater or freshwater and requires cleaning at least once a day while treatment is continuously performed; and
a ballast tank storing ballast water treated by the ballast water treatment apparatus,
wherein a service tank storing ballast treated water treated by the ballast water treatment apparatus is provided, and the ballast treated water in the service tank is made available for cleaning of the ballast water treatment apparatus.

2. The ballast water utilization system according to claim 1, wherein the ballast water treatment apparatus is a filtering apparatus separating and removing microorganisms and bacteria or a treatment apparatus using mechanical shear.

3. The ballast water utilization system according to claim 1, wherein the ballast water treatment apparatus includes a filtering apparatus separating and removing microorganisms and bacteria and a sterilizing apparatus placed in a following stage of the filtering apparatus and performing sterilization by using a bactericide or ultraviolet light.

4. The ballast water utilization system according to claim 1, wherein the ballast water treatment apparatus includes a treatment apparatus using mechanical shear and a sterilizing apparatus placed in a following stage of the treatment apparatus and performing sterilization by using a bactericide or ultraviolet light.

5. The ballast water utilization system according to claim 3, wherein the ballast treated water in the service tank is used as water to dilute a bactericide used in the sterilizing apparatus performing sterilization by using a bactericide.

6. The ballast water utilization system according to claim 1, wherein the ballast treated water in the service tank is introduced into a reverse osmosis membrane treatment apparatus to produce drinking water or reclaimed water.
